(19) United States
(12) Patent Application Publication
(10) Pub. No.: US 2022/0083076 A1
(43) Pub. Date: Mar. 17, 2022

(54) ACTION PLANNING APPARATUS, ACTION PLANNING METHOD, AND PROGRAM

(71) Applicant: SONY GROUP CORPORATION, TOKYO (JP)

(72) Inventor: KEISUKE MAEDA, TOKYO (JP)

(21) Appl. No.: 17/419,532

(22) PCT Filed: Dec. 2, 2019
(86) PCT No.: PCT/JP2019/046931

§ 371 Date: Jun. 29, 2021

(30) Foreign Application Priority Data
Jan. 11, 2019 (JP) 2019-003276

(51) Int. Cl. G05D 1/02

(52) U.S. Cl. CPC G05D 1/0274; G05D 1/0238; G05D 1/0217

(57) ABSTRACT

An action planning apparatus includes an action planning section that creates, to control action of a robot apparatus, on the basis of an outside world map, a higher action plan including an optimal solution achieving an action target and enabling derivation of a suboptimal solution different from the optimal solution.

### TECHNICAL FIELD

The present invention relates to an action planning apparatus, an action planning method, and a program.

### BACKGROUND ART

In general, to achieve an action target, a robot apparatus creates an action plan on the basis of an outside world map, and then acts on the basis of the action plan created.

For example, in a case of moving to a destination, the robot apparatus first uses a sensor and the like to observe obstacles to create an outside world map in which the presence probabilities of the obstacles are mapped. Then, the robot apparatus uses a graph search algorithm or the like to search for an optimum moving path that avoids obstacle areas with high obstacle presence probabilities and creates an action plan in which the robot apparatus moves through the optimum moving path searched for. Thus, the robot apparatus acts on the basis of the action plan created and can move to the destination while avoiding the obstacles.

For example, PTL 1 listed below discloses that an integrated map is created in which information regarding observed obstacles is overlapped on an environment information map and that on the integrated map, the optimum path is searched for that corresponds to a predetermined path along which the robot apparatus is moved while avoiding obstacles.

### CITATION LIST

### Patent Literature

### [PTL 1]

JP 2007-249632A

### SUMMARY

### Technical Problem

However, in a case where a dynamic obstacle varying in position (for example, another movable robot apparatus or the like) is present within the area of the outside world map, the obstacle area may vary in position over time. In such a case, the area of the outside world map passable at the time of creation of the action plan is impassable when the robot apparatus actually moves. Then, the robot apparatus creates an action plan again and may thus have difficulty performing smooth action.

Thus, there has been a demand for a technique enabling the robot apparatus to perform smooth action without re-creating an action plan despite a variation in outside world environment.

### Solution to Problem

According to the present disclosure, there is provided an action planning apparatus including an action planning section that creates, to control action of a robot apparatus, on the basis of an outside world map, a higher action plan including an optimal solution achieving an action target and enabling derivation of a suboptimal solution different from the optimal solution.

Additionally, according to the present disclosure, there is provided an action planning method including, using a calculation apparatus to create, to control action of a robot apparatus, on the basis of an outside world map, a higher action plan including an optimal solution achieving an action target and enabling derivation of a suboptimal solution different from the optimal solution.

Furthermore, according to the present disclosure, there is provided a program for causing a computer to function as an action planning section creating, to control action of the robot apparatus, on the basis of an outside world map, a higher action plan including an optimal solution achieving an action target and enabling derivation of a suboptimal solution different from the optimal solution.

### BRIEF DESCRIPTION OF DRAWINGS

FIG. 1A is an explanatory diagram depicting an example of a higher action plan created by a robot apparatus to move to a destination.

FIG. 1B is an explanatory diagram depicting an example of a lower action plan used to actually control the robot apparatus during movement to the destination.

FIG. 2 is a block diagram depicting a functional configuration of a control apparatus according to an embodiment of the present disclosure.

FIG. 3 is an explanatory diagram illustrating a higher action plan including a plurality of action plans.

FIG. 4 is an explanatory diagram illustrating a higher action plan with distributions created on the basis of a plurality of paths.

FIG. 5A is an explanatory diagram illustrating a higher action plan with distributions created on the basis of an optimal path.

FIG. 5B is another explanatory diagram illustrating a higher action plan with distributions created on the basis of an optimal path.

FIG. 6A is a flowchart illustrating the former half of a flow of creation of an action plan by a higher action planning section.

FIG. 6B is a flowchart illustrating the latter half of a flow of creation of an action plan by the higher action planning section.

FIG. 7 is a block diagram illustrating a functional configuration of a control apparatus according to a modified example of the embodiment.

FIG. 8A is an explanatory diagram illustrating higher action plans for the robot apparatus and a cooperating robot apparatus, respectively.

FIG. 8B is another explanatory diagram illustrating a lower action plan for the robot apparatus and the cooperating robot apparatus, respectively.

FIG. 9 is a block diagram depicting an example of a hardware configuration of a control apparatus according to an embodiment of the present disclosure.

### DESCRIPTION OF EMBODIMENTS

Suitable embodiments of the present disclosure will be described below in detail with reference to the attached drawings. Note that, in the specification and drawings, components having substantially the same functional configurations are assigned the same reference signs, and duplicate descriptions are omitted.

Note that the description below is in the following order.

1. Outline of Technique according to Present Disclosure

2. Configuration Example of Control Apparatus

3. Operation Example of Control Apparatus

4. Modified Example

5. Hardware Configuration Example

6. Conclusion

### 1. Outline of Technique according to Present Disclosure

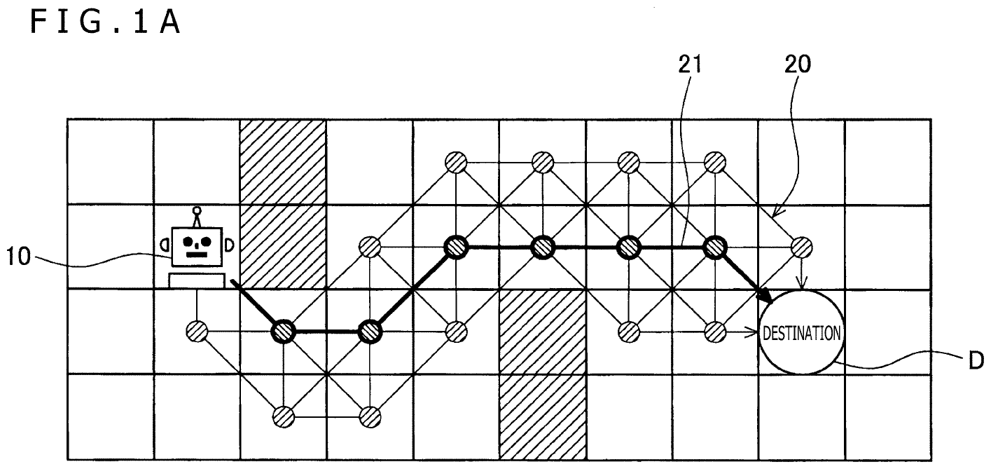

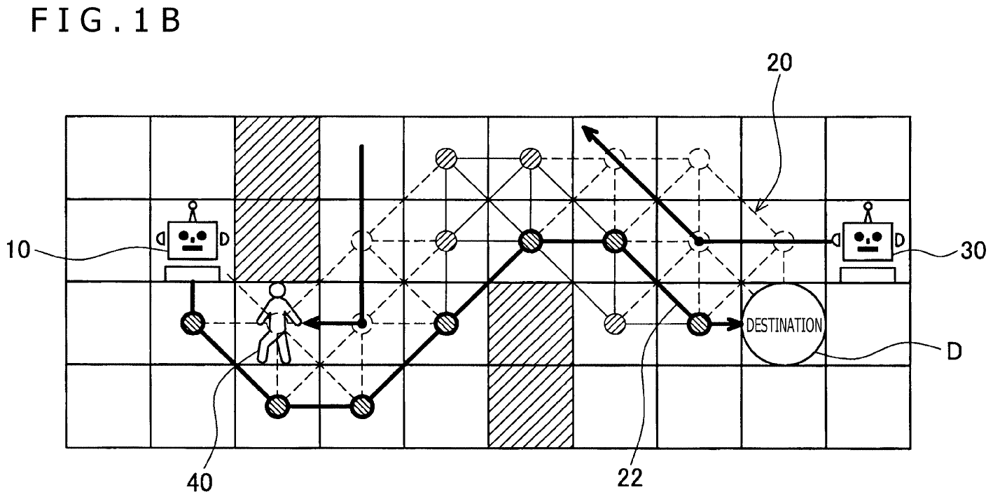

First, with reference to FIG. 1A and FIG. 1B, an outline of a technique according to the present disclosure will be described.

Note that movement of a robot apparatus to a destination is illustrated below as action of the robot apparatus but that the technique according to the present disclosure is not limited to the illustration below. The technique according to the present disclosure can be applied to various actions of the robot apparatus other than the movement to the destination. Additionally, the robot apparatus may be a movable body or a manipulator apparatus or may be a robot apparatus in another mode.

To control action of the robot apparatus, the technique according to the present disclosure creates a higher action plan including an optimal solution achieving an action target and enabling derivation of a suboptimal solution different from the optimal solution. Specifically, the higher action plan is not unambiguously defined and has a plurality of choices or distributions. To allow the robot apparatus to actually act, a lower action plan unambiguously defining the action of the robot apparatus is created on the basis of the higher action plan as described above.

In the technique according to the present disclosure, a higher action plan including a plurality of choices or distributions is created in advance to allow the action of the robot apparatus to be controlled without re-creating the higher action plan even in a case of a rapid change in outside world environment, a change in the position of an obstacle, or the like. In other words, a plurality of action plans can be derived from the higher action plan, and thus according to the outside world environment during action, the robot apparatus can derive an appropriate action plan from the higher action plan as a lower action plan.

Now, the technique according to the present disclosure will be specifically described with reference to FIG. 1A and FIG. 1B. FIG. 1A is an explanatory diagram depicting an example of the higher action plan created by the robot apparatus to move to a destination. FIG. 1B is an explanatory diagram depicting an example of the lower action plan used to actually control the robot apparatus in moving to the destination.

For example, as illustrated in FIG. 1A, in a case where a robot apparatus 10 moves to a destination D, the robot apparatus 10 first creates an outside world map including a two-dimensional matrix data, on the basis of environment information regarding the outside world. Then, the robot apparatus 10 applies a graph search algorithm such as a Dikstra's algorithm or an A* algorithm to the outside world map created to search for an optimal path 21 corresponding to an optimal solution to the destination D.

At this time, in the technique according to the present disclosure, the robot apparatus 10 searches an optimal path 21 and a path group 20 of a plurality of paths including suboptimal solutions to create a higher action plan including the optimal path 21 and the path group 20 of the plurality of paths.

Then, the robot apparatus 10 derives, from the higher action plan, a lower action plan used to actually control the action of the robot apparatus 10, and moves to the destination D on the basis of the lower action plan.

However, as depicted in FIG. 1B, when the robot apparatus 10 actually acts, dynamic obstacles that did not exist at the time of creation of the higher action plan, such as another robot apparatus 30 and a person 40, may enter the range of the higher action plan.

In the technique according to the present disclosure, the robot apparatus 10 can derive an appropriate moving path 22 avoiding the dynamic obstacles from the higher action plan on the basis of the environment information regarding the outside world at the time of actual action of the robot apparatus 10. This allows the robot apparatus 10 to derive the appropriate lower action plan from the higher action plan and control the action on the basis of the lower action plan, without re-creating the higher action plan despite a variation in outside world environment.

Note that the higher action plan need not be an action plan including the optimal path 21 and the path group 20 of the plurality of paths as depicted in FIG. 1A and FIG. 1B. For example, the higher action plan may be an action plan with distributions or acceptable ranges. Specifically, the higher action plan may be an action plan in which possible positions and orientations of the robot apparatus 10 are represented by distributions based on weighting. In such a case, the lower action plan is created in consideration of weighting within the ranges of the distributions or the acceptable ranges defined in the higher action plan.

As described above, in the technique according to the present disclosure, the robot apparatus 10 creates a higher action plan that is not unambiguously defined and that includes suboptimal solutions other than the optimal solution, and can thus derive the appropriate lower action plan from the higher action plan according to the outside world environment.

Consequently, the technique according to the present disclosure can make the action plan for the robot apparatus 10 more robust with respect to the outside world environment. Additionally, the technique according to the present disclosure enables the amount of calculation required to create action plans to be made smaller than in a case where the robot apparatus 10 re-creates an action plan after detecting a variation in the outside world environment. Furthermore, the robot apparatus suspends the action in re-creating an action plan, but the technique according to the present disclosure enables the action of the robot apparatus to be prevented from being suspended. Thus, the technique according to the present disclosure enables the robot apparatus 10 to act more smoothly.

### 2. Configuration Example of Control Apparatus

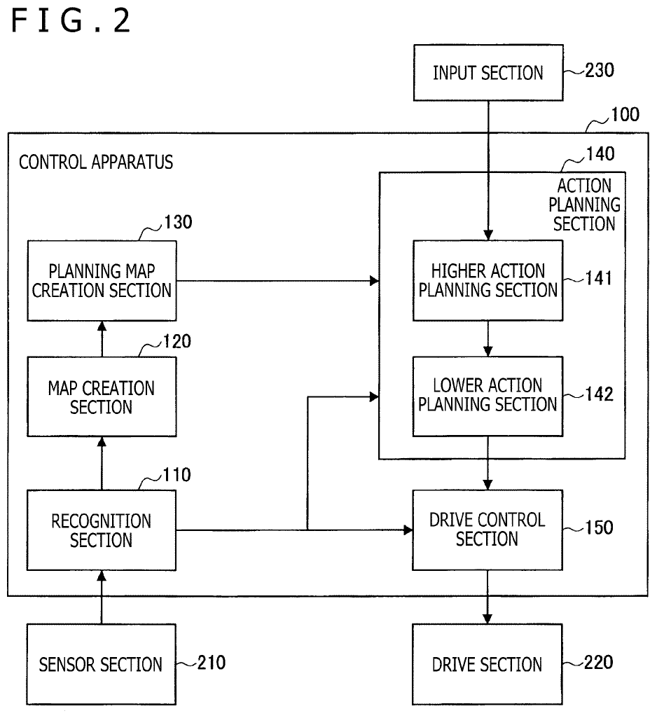

Now, with reference to FIG. 2, a configuration example of a control apparatus 100 according to an embodiment of the present disclosure described above in brief. FIG. 2 is a block diagram illustrating a functional configuration of the control apparatus 100 according to the present embodiment.

As depicted in FIG. 2, the control apparatus 100 controls a drive section 220 on the basis of environment information acquired by a sensor section 210 in order to achieve an action target input from an input section 230. This allows the control apparatus 100 to control the action of the robot apparatus 10. For example, the control apparatus 100 includes a recognition section 110, a map creation section 120, a planning map creation section 130, an action planning section 140, and a drive control section 150.

Note that the control apparatus 100 may be provided inside the robot apparatus 10 along with the sensor section 210 and the drive section 220. Alternatively, on the basis of transmission and reception of information to and from the robot apparatus 10 via a network or the like, the control apparatus 100 may be provided outside the robot apparatus 10.

The sensor section 210 includes a sensor acquiring environment information regarding the outside world of the robot apparatus 10 and a sensor acquiring subject apparatus information regarding the robot apparatus 10. For example, as a sensor acquiring environment information regarding the outside world of the robot apparatus 10, the sensor section 210 may include any of various cameras such as an RGB camera, a gray scale camera, a stereo camera, a depth camera, an infrared camera, or a ToF (Time of Flight) camera. Additionally, as a sensor acquiring environment information regarding the outside world of the robot apparatus 10, the sensor section 210 may include any of various distance measurement sensors such as a LIDAR (Laser Imaging Detection and Ranging) sensor or an RADAR (Radio Detecting and Ranging) sensor. Further, as a sensor acquiring environment information regarding the outside world of the robot apparatus 10, the sensor section 210 may include a sensor such as a microphone, an illuminometer, a thermometer, or a hygrometer. On the other hand, as a sensor acquiring subject apparatus information regarding the robot apparatus 10, the sensor section 210 may include, for example, an encoder, a voltmeter, an ammeter, a strain gauge, a pressure gauge, an IMU (Inertial Measurement Unit), or the like.

However, the sensor section 210 may include a well-known sensor other than the above-described sensor as long as the sensor section 210 can acquire environment information regarding the surroundings of the robot apparatus 10 or subject apparatus information regarding the robot apparatus 10.

The recognition section 110 recognizes an environmental state of the outside world of the robot apparatus 10 or the subject apparatus state of the robot apparatus 10 on the basis of the information acquired by the sensor section 210. Specifically, the recognition section 110 performs obstacle recognition, shape recognition, object recognition, marker recognition, character recognition, white line recognition, lane recognition, or voice recognition on the basis of the environment information acquired by the sensor section 210 to recognize the environmental state of the outside world of the robot apparatus 10. Additionally, the recognition section 110 may perform position recognition, state-of-motion (speed, acceleration, jerk, angular velocity, or angular acceleration) recognition, or apparatus body state (remaining battery level, temperature, articular angle, or the like) on the basis of the subject apparatus information acquired by the sensor section 210 to recognize the subject apparatus state of the robot apparatus 10.

Any of the above-described types of recognition by the recognition section 110 can be achieved by using well-known recognition techniques. The recognition by the recognition section 110 may be performed, for example, on the basis of a predetermined rule or a machine learning algorithm.

The map creation section 120 creates a map illustrating the environmental state of the outside world corresponding to a recognition result from the recognition section 110. The map creation section 120 may create, for example, an obstacle map or a movement area map illustrating areas passable by the robot apparatus 10, an object map illustrating the presence positions of various objects, or a topology map indicating the names of the areas, the relevance among the areas, or the meanings of the areas.

More specifically, the map creation section 120 may create a map for movement expressing passable areas and obstacle areas and a moving cost for each area, may create an object map expressing the names, positions, shapes, and presence areas of objects or locations, may create a topology map expressing connections and passing directions between the locations, or may create a road map expressing the positions, road widths, inclinations, and curvatures of passage areas connecting the locations. Note that the map creation section 120 may create a plurality of different types of maps according to intended use, type, or condition.

The planning map creation section 130 creates an action planning map including information required to create an action plan for the robot apparatus 10 and embedded in the map on the basis of the map illustrating the environment of the outside world created by the map creation section 120 and the subject apparatus information regarding the robot apparatus 10. Specifically, the planning map creation section 130 determines what meanings the areas and objects included in the map illustrating the environment of the outside world have to the robot apparatus 10, and embeds the meanings determined in the map to create an action planning map.

For example, the planning map creation section 130 can create an action planning map by embedding evaluation information corresponding to apparatus body characteristics and action characteristics of the robot apparatus 10, in the map illustrating the environment of the outside world to create an action planning map. The use of such an action planning map allows the action planning section 140 in a later stage of the planning map creation section 130 to create an action plan corresponding to the apparatus body characteristics or action characteristics of the robot apparatus 10. Note that the planning map creation section 130 may create a plurality of different types of action planning maps according to the intended use, type, or condition.

For example, in a case where the robot apparatus 10 is of a wheel type, the planning map creation section 130 can set, as impassable areas, map areas corresponding to puddles or holes present on the ground surface. For example, in a case where the robot apparatus 10 is a waterproof legged robot apparatus, the planning map creation section 130 can set, as passable areas, map areas corresponding to puddles or holes present on the ground surface. For example, in a case where the robot apparatus 10 is a flying body such as a drone, the planning map creation section 130 can set, as passable areas, map areas where an obstacle is present at a position lower than a flying enabled height.

The input section 230 outputs the action target of the robot apparatus 10 on the basis of an input from a user. Specifically, in a case where the user inputs a destination for the robot apparatus 10 to the input section 230, the input section 230 may output an action target “movement to the destination.” The input section 230 may include an input apparatus via which the user inputs information, for example, a touch panel, a keyboard, a mouse, a button, a microphone, a switch, a lever, or the like, and an input control circuit generating an input signal on the basis of the information input.

The action target output from the input section 230 is input to the action planning section 140. For example, the action target “movement to the destination” may include the location of the destination, the state of motion of the robot apparatus 10 at the destination, the point of time of arrival at the destination, a relative distance to an obstacle on a path to the destination, and the like.

Note that the robot apparatus 10 may further include a display section providing information to the user using images or characters. The display section can use images or characters to present the user with performable actions, a map for setting an action target, an action plan for achieving the action target, or the like. This allows the user to provide the robot apparatus 10 with a more appropriate action target.

The action planning section 140 creates an action plan for achieving the action target on the basis of the action planning map created by the planning map creation section 130 and the subject apparatus state of the robot apparatus 10 recognized by the recognition section 110. Specifically, the action planning section 140 includes a higher action planning section 141 and a lower action planning section 142 and creates action plans in stages by each of the higher action planning section 141 and the lower action planning section 142.

Note that the action target may be input to the input section 230 by the user or may be saved in a storage region of the control apparatus 100 in advance.

To achieve the action target, the higher action planning section 141 creates a higher action plan corresponding to a global action plan on the basis of the action planning map created by the planning map creation section 130 and the subject apparatus state of the robot apparatus 10 recognized by the recognition section 110. Specifically, the higher action plan includes an optimal solution and a plurality of choices or distributions. The higher action planning section 141 creates a higher action plan that is not unambiguously defined and that has a changeable acceptable range, allowing the action plan for the robot apparatus 10 to be made more robust with respect to a variation in the outside world environment. For example, the higher action planning section 141 may create a list of actions for transitioning the subject apparatus state of the robot apparatus 10 to a state in which the action target is achieved.

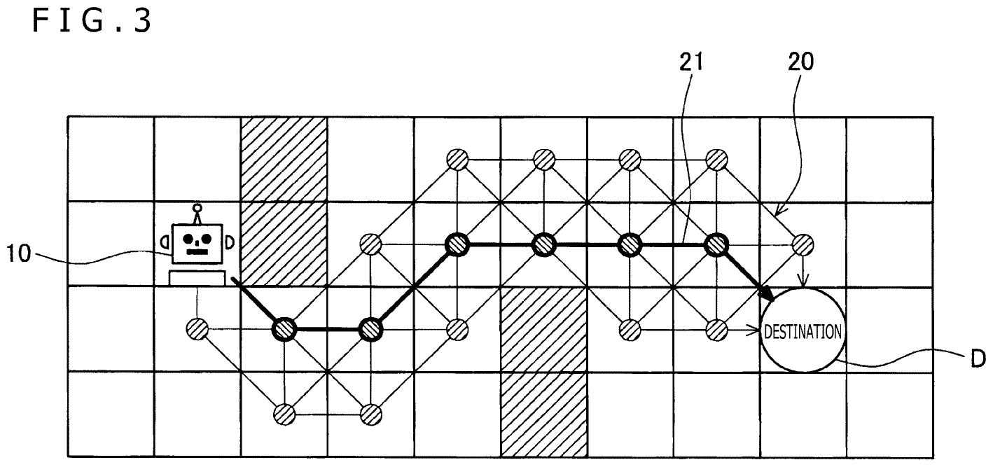

Now, an example of the higher action plan created by the higher action planning section 141 will be described with reference to FIGS. 3 to 5B.

For example, FIG. 3 is an explanatory diagram illustrating the higher action plan including a plurality of action plans. In FIG. 3, the action planning map is a two-dimensional obstacle map, and the action target is arrival of the robot apparatus 10 at the destination D.

In a case where such a higher action plan is created, the higher action planning section 141 creates a graph structure in which grids of the obstacle map correspond to nodes and in which the adjacent grids are connected by edges, and uses a graph search algorithm for the graph structure to search for an access path to the destination D. In other words, by performing searches related to “which grids need to be passed in sequence to allow the destination D to be reached,” the higher action planning section 141 can search for the optimal path 21 corresponding to the optimal solution.

Additionally, in the present embodiment, the higher action planning section 141 searches for a plurality of suboptimal solutions in addition to the optimal path 21 to search for the path group 20 including a plurality of paths to reach the destination D. Thus, by organizing the optimal path 21 to the destination D and the path group 20 including the plurality of paths corresponding to the suboptimal solutions, the higher action planning section 141 can create a higher action plan including the plurality of paths. Consequently, in a case where an unexpected dynamic obstacle enters the optimal path 21, the lower action planning section 142 described below can derive, from the path group 20, such a path as avoids the obstacle.

The number of paths included in the path group 20 may be set by the user or by the control apparatus 100 on the basis of the action planning map. For example, in an outside world environment in which a large number of dynamic obstacles are present or in which a large number of obstacles cause poor visibility, the number of the plurality of paths included in the path group 20 may be set to a larger value in order to improve the flexibility of the lower action plan to be derived.

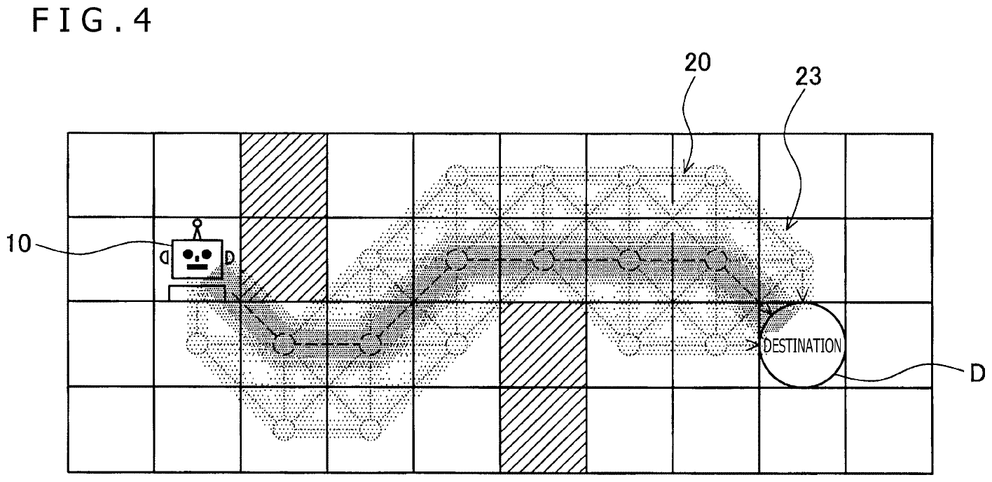

For example, FIG. 4 is an explanatory diagram illustrating a higher action plan with distributions created on the basis of a plurality of paths. In FIG. 4, as is the case with FIG. 3, the action planning map is a two-dimensional obstacle map, and the action target is arrival of the robot apparatus 10 at the destination D.

In a case where such a higher action plan is created, first, the higher action planning section 141 uses the graph search algorithm to search for the path group 20 to reach the destination D. Then, the higher action planning section 141 determines Gaussian distributions around points arranged on each path of the path group 20 at regular intervals and weights the Gaussian distributions using the reciprocals of costs (that is, weights the Gaussian distributions such that priority increases with decreasing cost), thus determining a weighted average distribution. This allows the higher action planning section 141 to create a higher action plan 23 with distributions. Consequently, the lower action planning section 142 described below can derive an appropriate path within the ranges of the distributions, from the higher action plan 23, according to the outside world environment at the time of performance of an action.

The spreads of the Gaussian distributions used in deriving the higher action plan 23 with distributions may be set by the user or by the control apparatus 100 on the basis of the action planning map. For example, in the outside world environment in which a large number of dynamic obstacles are present or in which a large number of obstacles cause poor visibility, the spreads of the Gaussian distributions may be set to larger values in order to improve the flexibility of the lower action plan to be derived.

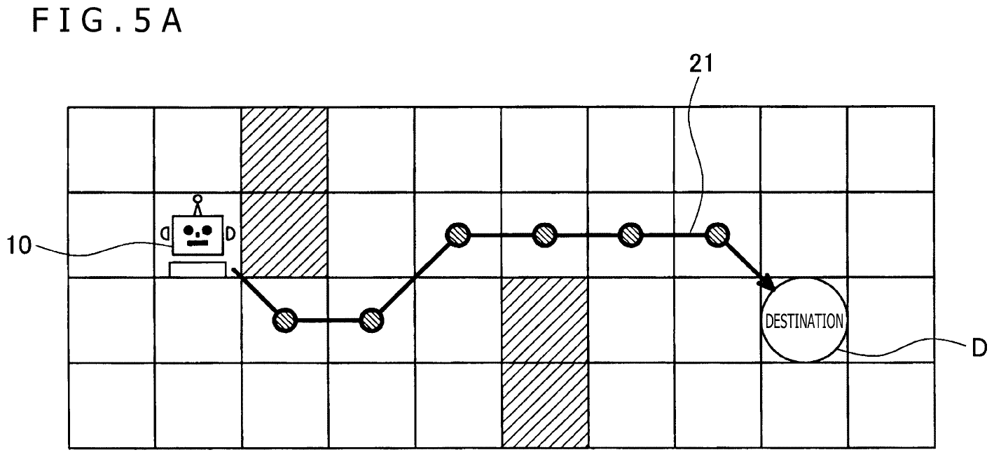

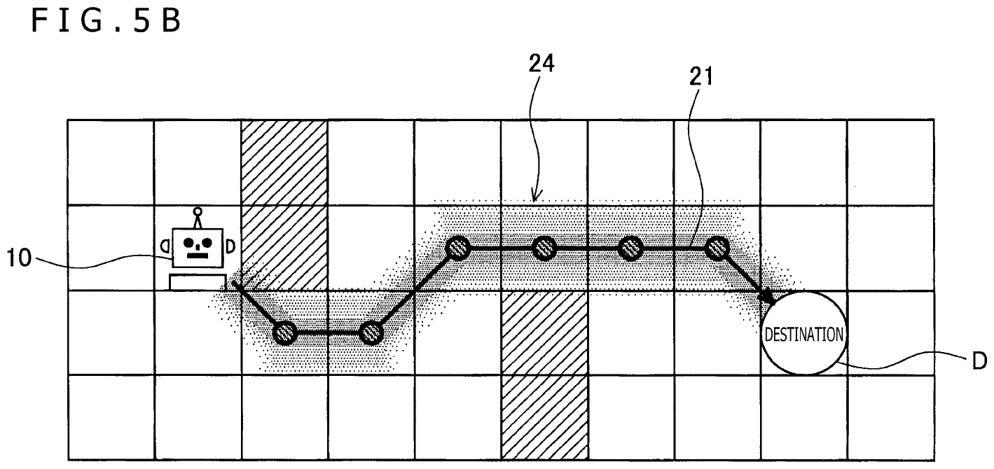

For example, FIG. 5A and FIG. 5B are explanatory diagrams illustrating a higher action plan with distributions created on the basis of the optimal path. In FIG. 5A and FIG. 5B, as is the case with FIG. 3, the action planning map is a two-dimensional obstacle map, and the action target is arrival of the robot apparatus 10 at the destination D.

In a case where such a higher action plan is created, first, the higher action planning section 141 uses the graph search algorithm to search for a single optimal path 21 to reach the destination D as is the case with FIG. 5A. Then, as depicted in FIG. 5B, the higher action planning section 141 sets, from the optimal path 21, Gaussian distributions spreading in a traveling direction on the optimal path 21 and in the vertical direction, and overlaps the Gaussian distributions with one another. This allows the higher action planning section 141 to create a higher action plan 24 with distributions. Consequently, the lower action planning section 142 described below can derive an appropriate path within the ranges of the distributions, from the higher action plan 24, according to the outside world environment at the time of performance of an action.

The spreads of the Gaussian distributions used in deriving the higher action plan 24 with distributions may be set by the user or by the control apparatus 100 on the basis of the action planning map. For example, in the outside world environment in which a large number of dynamic obstacles are present or in which a large number of obstacles cause poor visibility, the spreads of the Gaussian distributions may be set to larger values in order to improve the flexibility of the lower action plan to be derived.

Additionally, the spread of the Gaussian distribution may be set to vary with position of the optimal path 21. For example, the spreads of the Gaussian distributions in areas around dynamic obstacles may be set to larger values in order to improve the flexibility of the lower action plan to be derived. Additionally, the spreads of the Gaussian distributions in areas around a start point of movement and the destination D may be set to smaller values because a large number of constraint conditions are imposed on these areas.

Note that, in the description above, the Gaussian distributions are used to derive the higher action plans 23 and 24 with destinations but that the present embodiment is not limited to such illustrations. The higher action planning section 141 may use distributions other than the Gaussian distributions to create the higher action plans 23 and 24.

The lower action planning section 142 creates, from the higher action plan, a lower action plan actually used to control the robot apparatus 10 on the basis of the action planning map created by the planning map creation section 130 and the subject apparatus state of the robot apparatus 10 recognized by the recognition section 110. Specifically, the lower action plan is unambiguously defined and derived from a higher action plan with a plurality of choices or distributions. On the basis of the information regarding the outside world environment at the time of actual action of the robot apparatus 10, the lower action planning section 142 creates, from the higher action plan, a lower action plan used to control the robot apparatus 10. This allows the lower action planning section 142 to flexibly create an appropriate action plan according to the outside world environment at the time of actual action of the robot apparatus 10. For example, the lower action planning section 142 may create a list of actions for transitioning the subject apparatus state of the robot apparatus 10 to a halfway state in the higher action plan.

For example, as described with reference to FIG. 3, in a case where the higher action plan is an action plan including a plurality of paths, the lower action planning section 142 may use an evaluation function to select the optimal path from the higher action plan with the plurality of choices and create a lower action plan following the path.

Additionally, as described with reference to FIGS. 4 to 5B, in a case where the higher action plan is an action plan with distributions, the lower action planning section 142 may use the evaluation function to select the optimal path from the distributions of the higher action plan and may create a lower action plan for following the path. In such a case, the lower action planning section 142 can create an appropriate lower action plan by using the graph search algorithm with very high costs set for the areas outside the distributions in the higher action plan.

The evaluation function that can be used by the lower action planning section 142 to create a lower action plan from the higher action plan is, for example, the followability of the subject apparatus state of the robot apparatus 10, the possibility of a collision between the robot apparatus 10 and an obstacle, closeness to a previously selected action history, or the like.

Additionally, the lower action planning section 142 can use the magnitude of deviation of the optimal solution from the action plan as the evaluation function used in creating a lower action plan from the higher action plan. In such a case, the lower action planning section 142 can create a lower action plan from the higher action plan in such a manner as to reduce the magnitude of deviation of the optimal solution from the action plan.

In this regard, the lower action planning section 142 may differ from the higher action planning section 141 in at least one of the period of creation of action plans or the range of creation of action plans.

For example, the lower action planning section 142 may create spatially or temporally more local action plans than the higher action planning section 141. This allows the lower action planning section 142 to create a lower action plan with halfway states in the higher action plan set as targets, and can thus create action plans adapted to the actual outside world environment instead of an expected outside world environment.

Additionally, the lower action planning section 142 may create action plans with a shorter period than the higher action planning section 141. Accordingly, by creating action plans with a shorter period, the lower action planning section 142 can create action plans adapted to the subject apparatus state and outside world environment varying. Additionally, by creating action plans with a shorter period, the lower action planning section 142 can more easily create a lower action plan that avoids dynamic obstacles.

Further, the lower action planning section 142 creates a lower action plan in consideration of a dynamic object, from a higher action plan created in consideration of a static object. This allows the objects of interest to be separately assigned to the higher action planning section 141 and the lower action planning section 142, thus enabling a reduction in the amount of calculation by both the higher action planning section 141 and the lower action planning section 142.

Note that each of the higher action planning section 141 and the lower action planning section 142 may create action plans with a hierarchical structure in terms of a course of action, long-term action, or short-term action. Additionally, the higher action planning section 141 and the lower action planning section 142 may each generate plural action plans that are executed in parallel. For example, the higher action planning section 141 and the lower action planning section 142 may each generate, in parallel, a topological path plan using a wide-area topological map, a coordinate path plan using obstacles within an observation range, or a motion plan including dynamics executed by the robot apparatus 10.

The drive control section 150 outputs control instructions to the drive section 220 on the basis of the lower action plan created by the lower action planning section 142 of the action planning section 140 and the subject apparatus state of the robot apparatus 10. The control instructions cause the robot apparatus 10 to act in accordance with the lower action plan. Specifically, the drive control section 150 may detect an error between the state of the robot apparatus 10 planned in the lower action plan and the current subject apparatus state of the robot apparatus 10 and may output, to the drive section 220, a control instruction to reduce the detected error. Note that the drive control section 150 may generate, in a hierarchical manner, control instructions output to the drive section 220.

The drive section 220 is driven on the basis of the control instructions from the drive control section 150 to cause the robot apparatus 10 to act in accordance with the lower action plan. Specifically, the drive section 220 is a module that provides outputs to the real space. For example, the drive section 220 may be an engine, a motor, a speaker, a projector, a display, a light emitter (for example, a light bulb, a LED, a laser, or the like), or the like.

In the configuration described above, the control apparatus 100 can create action plans for the robot apparatus 10 in two separate stages including the higher action plan with a plurality of choices or distributions and the lower action plan unambiguously defined. Accordingly, in a case where the outside world environment varies, the control apparatus 100 is only required to create a spatially or temporally local lower action plan without re-creating a higher action plan, allowing the action of the robot apparatus 10 to be more smoothly controlled.

### 3. Operation Example of Control Apparatus

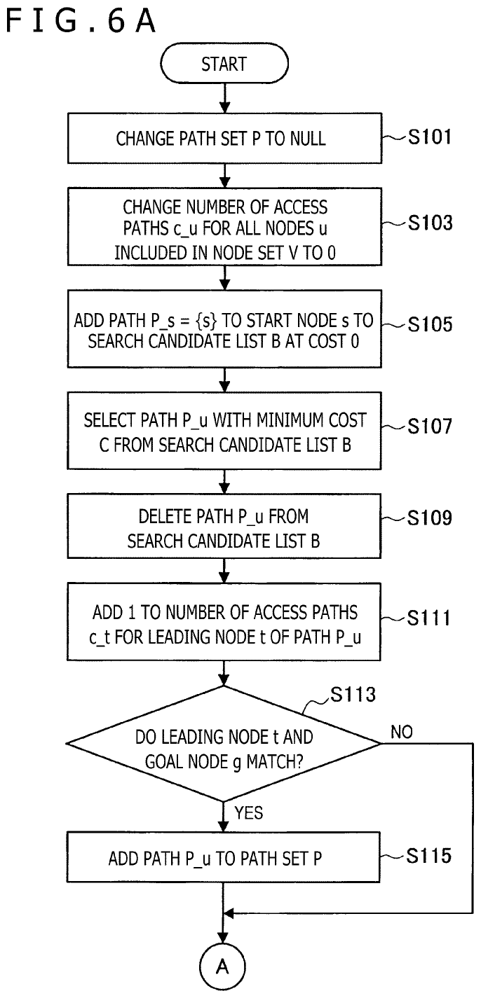

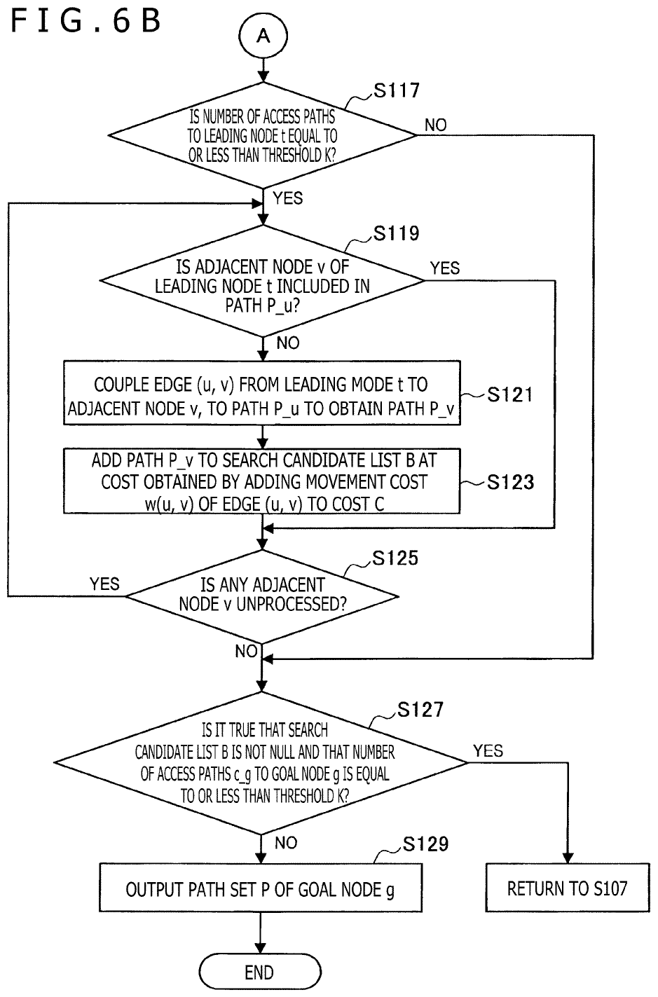

Now, an operation example of the control apparatus 100 according to the present embodiment will be described with reference to FIG. 6A and FIG. 6B. FIG. 6A is a flowchart depicting the former half of flow of creation of an action plan by the higher action planning section 141, and FIG. 6B is a flowchart depicting the former half of flow of creation of an action plan by the higher action planning section 141.

Note that the operations by the recognition section 110, the map creation section 120, the planning map creation section 130, and the drive control section 150 are substantially similar to a typical flow of operations and that description of the operations is omitted.

As depicted in FIG. 6A, first, the higher action planning section 141 changes a path set P to null (S101). Then, the higher action planning section 141 changes, to 0, the number of access paths c_u for all nodes u included in a node set V (S103). Subsequently, the higher action planning section 141 adds a path P_s={s} to a start node s, to a search candidate list B with a cost of 0 (S105). Subsequently, the higher action planning section 141 selects a path P_u with a minimum cost C from the search candidate list B (S107), and deletes the path P_u from the search candidate list B (S109). Then, the higher action planning section 141 increases, by one, the number of access paths c_t for a leading node t of the path P_u (S111).

In this regard, the higher action planning section 141 determines whether or not the leading node t coincides with a goal node g (S113). In a case where the leading node t coincides with the goal node g (S113/Yes), the higher action planning section 141 adds the path P_u to a path set P (S115). On the other hand, in a case where the leading node t does not coincide with the goal node g (S113/No), the higher action planning section 141 does not add the path P_u to the path set P.

Then, as depicted in FIG. 6B, the higher action planning section 141 determines whether or not the number of access paths to the leading node t is equal to or less than a threshold K (S117). In a case where the number of access paths to the leading node t is equal to or less than a threshold K (S117/Yes), the higher action planning section 141 determines whether or not an adjacent node v of the leading node t is included in the path P_u (S119).

In a case where the adjacent node v of the leading node t is not included in the path P_u (S119/No), the higher action planning section 141 couples, to the path P_u, an edge (u, v) from the leading node t to the adjacent node v, to form a path P_v (S121). Then, the higher action planning section 141 adds the path P_v to the search candidate list B at a cost obtained by adding a movement cost w(u, v) of the edge (u, v) to the cost C (S123). Subsequently, the higher action planning section 141 determines whether or not the leading node t has any unprocessed adjacent node v (S125). Note that, in a case where the adjacent node v of the leading node t is included in the path P_u (S119/Yes), the higher action planning section 141 omits steps S121 and S123 and performs the determination in step S125.

In a case where any unprocessed adjacent node v is present (S125/Yes), the higher action planning section 141 returns to step S119, and executes step S119 and the subsequent steps for the unprocessed adjacent node v. In a case where no unprocessed adjacent node v is present (S125/No) or the determination in step S117 indicates that the number of access paths to the leading node t is greater than the threshold K (S117/No), the higher action planning section 141 determines whether or not the search candidate list B is not null and the number of access paths c_g to the goal node g is equal to or less than the threshold K (S127).

In a case where the search candidate list B is not null and the number of access paths c_g to the goal node g is equal to or less than the threshold K (S127/Yes), the higher action planning section 141 returns to step S107 and similarly executes the subsequent steps on the path P_u with the minimum cost C in the search candidate list B. On the other hand, in a case where the search candidate list B is null or the number of access paths c_g to the goal node g is greater than the threshold K (S127/No), the higher action planning section 141 outputs the path set P for the goal node g as a higher action plan (S129). Such an operation allows the higher action planning section 141 to create a higher action plan.

Note that the higher action planning section 141 further determines a weighted average distribution resulting from weighting, with the reciprocals of costs, of Gaussian distributions for the respective paths in the path set P and may output the weighted average distribution obtained as a higher action plan.

A flow of operations of the higher action planning section 141 described above is substantially the same as a flow of an A* algorithm or a Dikstra's algorithm. However, the present embodiment differs from the A* algorithm or the Dikstra's algorithm in that the higher action planning section 141 does not stop calculation even after determining a path corresponding to the optimal solution and determines a plurality of paths corresponding to suboptimal solutions until the threshold K is reached. This allows the higher action planning section 141 to create a higher action plan including choices or distributions with the threshold K. Note that the threshold K may be set by the user, be set on the basis of the outside world environment illustrated by the action planning map, or be set on the basis of the cost or the mechanism of the robot apparatus 10.

Further, the higher action planning section 141 may determine the number of choices in the higher action plan or the magnitudes of distributions in the higher action plan on the basis of the time or amount of calculation required to create a higher action plan instead of the threshold K. For example, the higher action planning section 141 may create a higher action plan including a plurality of paths calculated at the point of time when the time or amount of calculation reaches a predetermined value. Further, the higher action planning section 141 sets choices for paths to be eliminated on the basis of the cost and the mechanism of the robot apparatus 10 and may exclude, from the higher action plan, the choices for the paths to be eliminated. This allows the higher action planning section 141 can exclude, from the higher action plan, positions and orientations of the robot apparatus 10 corresponding to specific points in the mechanism of the robot apparatus 10.

### 4. Modified Example

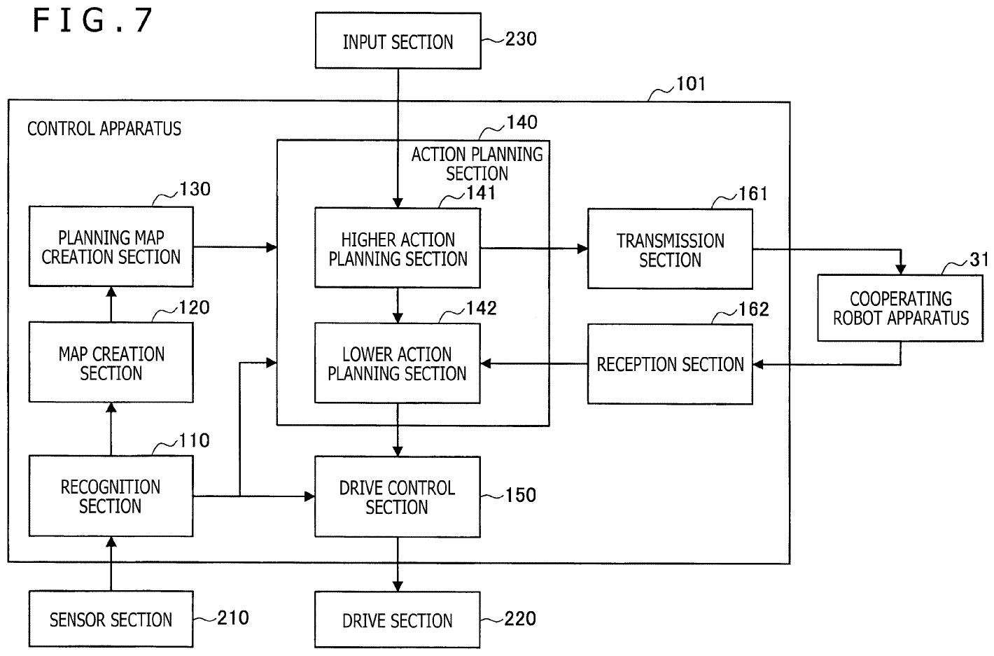

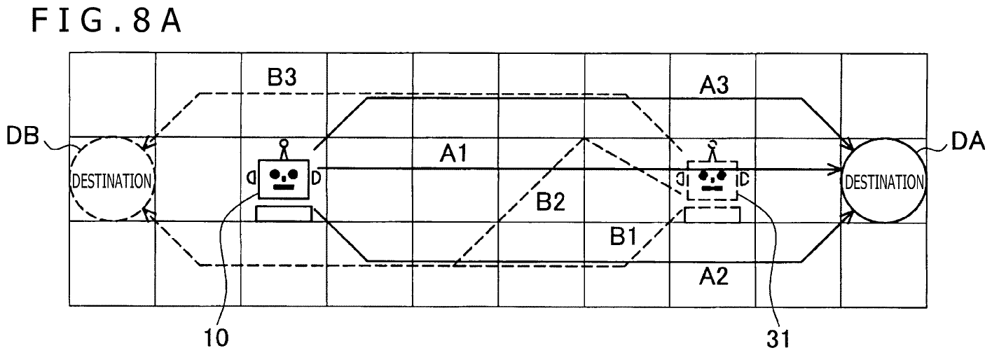

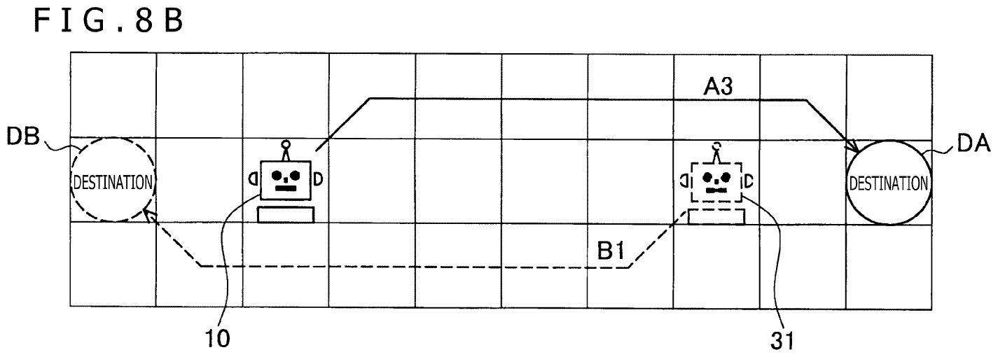

Now, a modified example of the control apparatus 100 according to the present embodiment will be described with reference to FIGS. 7 to 8B. FIG. 7 is a block diagram depicting a functional configuration of a control apparatus 101 according to the present modified example.

The control apparatus 101 according to the present modified example causes the robot apparatus 10 and an external cooperating robot apparatus 31 to share the higher action plan to perform smooth cooperating operations.

Specifically, as depicted in FIG. 7, the control apparatus 101 according to the present modified example differs from the control apparatus 100 described with reference to FIG. 2 in that the control apparatus 101 further includes a transmission section 161 transmitting the higher action plan to the cooperating robot apparatus 31 and a reception section 162 to which the cooperating robot apparatus 31 transmits the higher action plan. Note that differences in configuration between the control apparatus 100 and the control apparatus 101 will be described below and that components substantially similar to the corresponding components of the control apparatus 100 will not be described.

The transmission section 161 transmits, to the cooperating robot apparatus 31, the higher action plan created by the higher action planning section 141. The transmission section 161 may be a wireless communication module based on a well-known communication scheme and which can communicate with the cooperating robot apparatus 31 directly or via a network.

The reception section 162 receives, from the cooperating robot apparatus 31, the higher action plan for the cooperating robot apparatus 31. The reception section 162, like the transmission section 161, may be a wireless communication module based on a well-known communication scheme and which can communicate with the cooperating robot apparatus 31 directly or via a network.

Note that the transmission section 161 and the reception section 162 may be configured as a communication section that transmits and receives information to and from the cooperating robot apparatus 31.

The lower action planning section 142 creates a lower action plan actually used to control the robot apparatus 10, from the higher action plan for the robot apparatus 10, on the basis of the action planning map, the subject apparatus state of the robot apparatus 10, and a higher action plan for the cooperating robot apparatus 31. Unlike in the control apparatus 100 depicted in FIG. 2, the lower action planning section 142 creates a lower action plan further on the basis of the higher action plan for the cooperating robot apparatus 31. This enables the lower action planning section 142 to derive such a lower action plan as is prevented from interfering with the action of the cooperating robot apparatus 31.

Like the robot apparatus 10, the cooperating robot apparatus 31 is a robot apparatus creating action plans in stages separately including a higher action plan and a lower action plan. Specifically, the cooperating robot apparatus 31 creates a higher action plan corresponding to a global action plan with a plurality of choices or distributions, on the basis of the action target, the action planning map, and the subject apparatus state of the cooperating robot apparatus 31. Additionally, the cooperating robot apparatus 31 creates a lower action plan actually used to control the robot apparatus 10, from the higher action plan, on the basis of the action planning map and the subject apparatus state of the cooperating robot apparatus 31.

The cooperating robot apparatus 31 is, for example, a robot apparatus having an action target or range overlapping the robot apparatus 10, and thus importantly the cooperating robot apparatus 31 acts cooperatively with the robot apparatus 10 in such a manner as to prevent the action plan of the cooperating robot apparatus 31 from competing with the action plan of the robot apparatus 10. Now, the cooperating action between the robot apparatus 10 and the cooperating robot apparatus 31 will be described with reference to FIG. 8A and FIG. 8B. FIG. 8A is an explanatory diagram illustrating higher action plans of the robot apparatus 10 and the cooperating robot apparatus 31, respectively, and FIG. 8B is an explanatory diagram illustrating a lower action plan of the robot apparatus 10 and the cooperating robot apparatus 31, respectively.

As depicted in FIG. 8A and FIG. 8B, the robot apparatus 10 is moving to a destination DA, whereas the cooperating robot apparatus 31 is moving to a destination DB. However, in a case where the robot apparatus 10 and the cooperating robot apparatus 31 are present at the same position at the same time, a collision may occur because the robot apparatus 10 and the cooperating robot apparatus 31 have overlapping planed moving paths.

In such a case, in general, the robot apparatus 10 and the cooperating robot apparatus 31 share mutual action plans, then change conditions, re-create action plans, and re-share mutual action plans. The robot apparatus 10 and the cooperating robot apparatus 31 repeat sharing and re-creating action plans until there is no possibility of collision, allowing implementation of a cooperating action with no possibility of collision.

On the other hand, in the present modified example, the higher action plans created for the robot apparatus 10 and the cooperating robot apparatus 31 each include a plurality of choices or distributions. For example, in FIG. 8A, the higher action plan for the robot apparatus 10 includes moving paths A1, A2, and A3 to the destination DA, and the higher action plan for the cooperating robot apparatus 31 includes moving paths B1, B2, and B3 to the destination DB. Thus, by selecting, on the basis of a common evaluation function, a combination of action plans that prevents a collision caused by shared higher action plans, the robot apparatus 10 and the cooperating robot apparatus 31 can implement a cooperating action without performing re-creation and re-sharing of an action plan.

For example, the higher action plan depicted in FIG. 8A assumes that a cost c is set for the moving paths A1, A2, and A3 included in the higher action plan for the robot apparatus 10 and for the moving paths B1, B2, and B3 included in the higher action plan for the cooperating robot apparatus 31. The robot apparatus 10 and the cooperating robot apparatus 31 can select a combination of moving paths that implements a cooperating action in consideration of the presence of a collision depending on the combination of moving paths and the total cost.

TABLE 1

| | B1 c = 11 | B2 c = 19 | B3 c = 21 |
|---|---|---|---|
| A1 c = 8 | collide | collide | collide |
| A2 c = 10 | collide | collide | 31 |
| A3 c = 13 | 24 | 32 | collide |

In other words, by selecting, from combinations of moving paths that prevent a collision, a combination of moving paths A3 and B1 having a minimum total cost as depicted in FIG. 8B, the robot apparatus 10 and the cooperating robot apparatus 31 can select moving paths that prevent a collision between the robot apparatus 10 and the cooperating robot apparatus 31.

Additionally, the robot apparatus 10 and the cooperating robot apparatus 31 may select a combination of moving paths that prevents a collision on the basis of the priorities of the moving paths instead of the total costs of the moving paths. For example, the robot apparatus 10 and the cooperating robot apparatus 31 may select, from the combinations of moving paths that prevent a collision, such a combination as includes moving paths with the respective highest priorities. Further, the robot apparatus 10 and the cooperating robot apparatus 31 may select a combination of moving paths that prevents a collision on the basis of another evaluation function. For the evaluation function for selecting a combination of moving paths that prevents a collision, any evaluation function can be used as long as the evaluation function is shared between the robot apparatus 10 and the cooperating robot apparatus 31.

According to the present modified example, by sharing a higher action plan with a plurality of choices or distributions between the robot apparatus 10 and the cooperating robot apparatus 31, a lower action plan enabling a cooperating action can be derived from the range of the higher action plan. Consequently, according to the present modified example, the robot apparatus 10 and the cooperating robot apparatus 31 can perform a smooth cooperating action through one communication session without re-creating or re-sharing an action plan.

### 5. Hardware Configuration Example

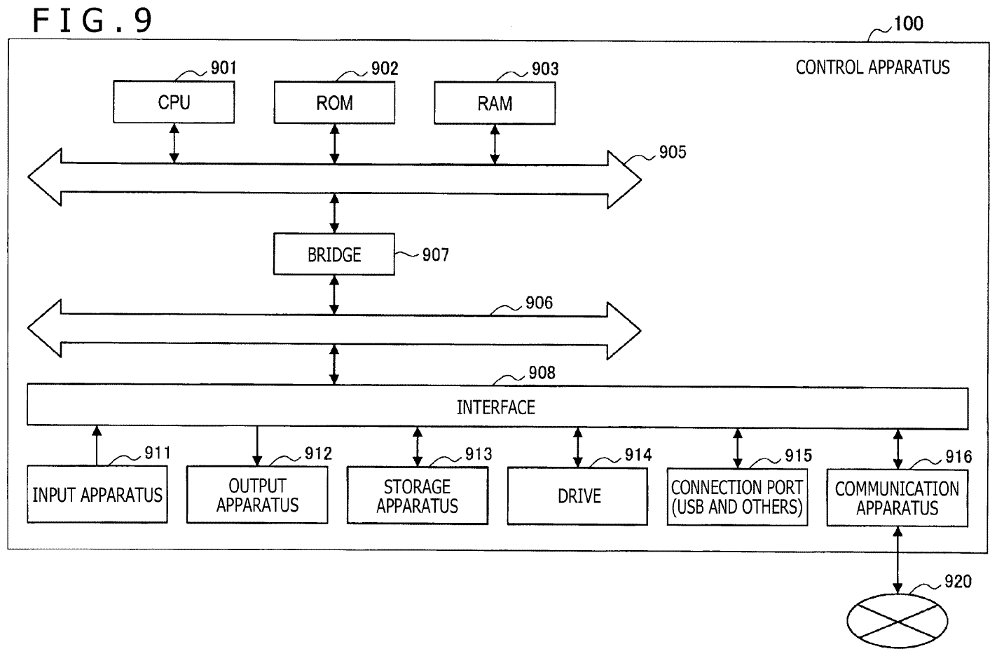

Now, an example of a hardware configuration of the control apparatus 100 according to the present embodiment will be described with reference to FIG. 9. FIG. 9 is a block diagram depicting an example of a hardware configuration of the control apparatus 100 according to the present embodiment.

As illustrated in FIG. 9, the control apparatus 100 includes a CPU (Central Processing Unit) 901, a ROM (Read Only Memory) 902, a RAM (Random Access Memory) 903, a host bus 905, a bridge 907, an external bus 906, an interface 908, an input apparatus 911, an output apparatus 912, a storage apparatus 913, a drive 914, a connection port 915, and a communication apparatus 916. The control apparatus 100 may include a processing circuit such as an electric circuit, a DSP, or an ASIC instead of or in addition to the CPU 901.

The CPU 901 functions as a calculation processing apparatus and a control apparatus to control operations in general within the control apparatus 100 in accordance with various programs. Additionally, the CPU 901 may be a microprocessor. The ROM 902 stores programs, calculation parameters, and the like that are used by the CPU 901. The RAM 903 temporarily stores programs used in execution by the CPU 901, parameters varying in the execution as appropriate, and the like. The CPU 901 may execute the functions of, for example, the recognition section 110, the map creation section 120, the planning map creation section 130, the action planning section 140, and the drive control section 150.

The CPU 901, the ROM 902, and the RAM 903 are connected together by a host bus 905 including a CPU bus and the like. The host bus 905 is connected to an external bus 906 such as a PCI (Peripheral Component Interconnect/Interface) bus via a bridge 907. Note that the host bus 905, the bridge 907, and the external bus 906 need not necessarily be separately configured and that these functions may be implemented in one bus.

The input apparatus 911 is an apparatus through which the user inputs information, for example, a mouse, a keyboard, a touch panel, a button, a microphone, a switch, a lever, or the like. Alternatively, the input apparatus 911 may be a remote control apparatus using infrared light or any other radio wave, or externally connected equipment such as a cellular phone or a PDA that can respond to operation by the control apparatus 100. Further, the input apparatus 911 may include, for example, an input control circuit or the like that generates input signals on the basis of information input by the user using the above-described input means.

The output apparatus 912 is an apparatus that can visually or auditorily notify information to the user. The output apparatus 912 is, for example, a display apparatus such as a CRT (Cathode Ray Tube) display apparatus, a liquid display apparatus, a plasma display apparatus, an EL (Electro Luminescence) display apparatus, a laser projector, an LED (Light Emitting Diode) projector, or a lamp, a sound output apparatus such as a speaker or a headphone, or the like.

The output apparatus 912 may output, for example, results obtained by various types of processing executed by the control apparatus 100. Specifically, the output apparatus 912 may visually display, in various formats such as text, image, table, or graph, results obtained by various types of processing executed by the control apparatus 100. Alternatively, the output apparatus 912 may convert audio signals such as sound data or audio data into analog signals and auditorily output the analog signals.

The storage apparatus 913 is an apparatus for data storage formed as an example of a storage section of the control apparatus 100. The storage apparatus 913 may be implemented by, for example, a magnetic storage device such as an HDD (Hard Disk Drive), a semiconductor storage device, an optical storage device, or a magneto optical storage device. For example, the storage apparatus 913 may include a storage medium, a recording apparatus recording data to the storage medium, a readout apparatus reading out data from the storage medium, an erasing apparatus erasing data recorded in the storage medium, and the like. The storage apparatus 913 may store programs executed by the CPU 901, various kinds of data, various kinds of data externally acquired, and the like.

The drive 914 is a reader writer for storage media that is built in the control apparatus 100 or installed externally to the control apparatus 100. The drive 914 reads out information recorded in a removable storage medium such as a magnetic disk, an optical disc, a magneto optical disk, or a semiconductor memory which is installed on the drive 914 and outputs the information to the RAM 903. Additionally, the drive 914 can write information to the removable storage medium.

The connection port 915 is an interface connected to external equipment. The connection port 915 is a connection opening that can transmit data to and from external equipment and may be, for example, a USB (Universal Serial Bus).

The communication apparatus 916 is an interface including a communication device for connection to a network 920. The communication apparatus 916 may be, for example, a communication card for a wired or wireless LAN (Local Area Network), LTE (Long Term Evolution), Bluetooth (registered trademark), or WUSB (Wireless USB). Additionally, the communication apparatus 916 may be a router for optical communication, a router for ADSL (Asymmetric Digital Subscriber Line), a modem for any of various types of communication, or the like. The communication apparatus 916 can transmit and receive signals and the like to and from, for example, the Internet or any other communication equipment in accordance with a predetermined protocol, for example, TCP/IP. The communication apparatus 916 may execute the functions of, for example, the transmission section 161 and the reception section 162.

Note that the network 920 is a wired or wireless transmission path for information. For example, the network 920 may include the Internet, public line networks such as telephone line networks or satellite communication networks, various LANs (Local Area Networks) including Ethernet (registered trademark), WANs (Wide Area Networks), or the like. Additionally, the network 920 may include leased line networks such as IP-VPN (Internet Protocol-Virtual Private Network).

Note that a computer program can be created that are used to cause hardware such as a CPU, a ROM, and a RAM built in the control apparatus 100 to fulfil functions equivalent to the functions of components of the control apparatus according to the present embodiment described above. Additionally, a storage medium storing the computer program can be provided.

### 6. Conclusion

As described above, even in a case where a change in outside world environment prevents an action plan created from being the optimal solution, the control apparatus 100 according to the present embodiment can continue action by selecting an action plan corresponding to a suboptimal solution. This enables the control apparatus 100 to reduce the amount of calculation for the overall processing compared to a case where the action plan is re-created in response to a change in outside world environment. This is because information used to determine suboptimal solutions can be acquired during determination of the optimal solution and because derivation of action plans each including a plurality of choices or distributions thus places only a small load on the control apparatus 100.

Additionally, even in a case where the action plan corresponding to the optimal solution fails to be used during performance of action, the control apparatus 100 can switch to an action plan corresponding to a suboptimal solution and continue the action without re-creating an action plan. This allows the control apparatus 100 to be prevented from being suspended during action to re-create an action plan.

Furthermore, in the control apparatus 101 according to the modified example, when plural robot apparatuses 10 perform a cooperating action, sharing, in advance, of action plans each with a plurality of choices or distributions enables a possible conflict between the actions of the plural robot apparatuses 10 without additional communication or the like.

The preferred embodiments of the present disclosure have been described in detail with reference to the attached drawings. However, the technical scope of the present disclosure is not limited to such examples. Obviously, a person having ordinary knowledge and skill in the art of the present disclosure may arrive at various changed or modified examples without departing from the scope of technical concepts set forth in claims, and it is apprehended that the changed or modified examples naturally belong to the technical scope of the present disclosure.

Additionally, the effects described herein are only explanatory or illustrative and are not restrictive. In other words, in addition to or instead of the above-described effects, the technique according to the present disclosure may produce effects obvious to a person skilled in the art from the description herein.

Note that configurations described below also belong to the technical scope of the present disclosure.

(1)

An action planning apparatus including:

an action planning section that creates, to control action of a robot apparatus, on the basis of an outside world map, a higher action plan including an optimal solution achieving an action target and enabling derivation of a suboptimal solution different from the optimal solution.

(2)

The action planning apparatus according to (1) described above, in which the higher action plan includes a plurality of action plans and includes at least an action plan corresponding to the optimal solution and an action plan corresponding to the suboptimal solution.

(3)

The action planning apparatus according to (1) described above, in which the higher action plan includes an action plan with a distribution.

(4)

The action planning apparatus according to (3) described above, in which the higher action plan is created by bringing a distribution to the action plan corresponding to the optimal solution.

(5)

The action planning apparatus according to (3) described above, in which the higher action plan is created by converting a plurality of overlapping action plans into a distribution.

(6)

The action planning apparatus according to (2) described above, in which the number of action plans included in the higher action plan is controlled on the basis of the outside world map.

(7)

The action planning apparatus according to any one of (3) to (5) described above, in which a magnitude of the distribution in the higher action plan is controlled on the basis of the outside world map.

(8)

The action planning apparatus according to any one of (1) to (7) described above, in which the action planning section includes a higher action planning section that creates the higher action plan and a lower action planning section that creates, on the basis of the higher action plan, a lower action plan used to actually control the robot apparatus.

(9)

The action planning apparatus according to (8) described above, in which the lower action planning section differs from the higher action planning section in at least one of a period of creation of an action plan or a range of creation of an action plan.

(10)

The action planning apparatus according to (9) described above, in which the lower action planning section creates an action plan within a range spatially or temporarily more local than the higher action planning section.

(11)

The action planning apparatus according to (9) or (10) described above, in which the higher action planning section creates the higher action plan in consideration of a static object, and the lower action planning section creates the lower action plan in consideration of a dynamic object.

(12)

The action planning apparatus according to any one of (8) to (11) described above, in which the lower action planning section creates the lower action plan on the basis of at least one of followability of a subject apparatus state of the robot apparatus, a possibility of a collision with an obstacle, or a previous action history.

(13)

The action planning apparatus according to any one of (8) to (12), in which the lower action planning section creates the lower action plan in such a manner as to reduce a deviation from an action plan corresponding to the optimal solution.

(14)

The action planning apparatus according to any one of (8) to (13), in which the lower action planning section creates an action plan up to an intermediate action target in the higher action plan.

(15)

The action planning apparatus according to any one of (8) to (14), further including:

a communication section that is able to communicate with a cooperating robot apparatus acting cooperatively with the robot apparatus,

in which the robot apparatus and the cooperating robot apparatus share the higher action plan via the communication section, and

the lower action planning section creates the lower action plan on the basis of each of the higher action plans.

(16)

The action planning apparatus according to (15) described above, in which the lower action planning section creates the lower action plan using an evaluation function common to the robot apparatus and the cooperating robot apparatus.

(17)

An action planning method including:

using a calculation apparatus to create, to control action of a robot apparatus, on the basis of an outside world map, a higher action plan including an optimal solution achieving an action target and enabling derivation of a suboptimal solution different from the optimal solution.

(18)

A program for causing a computer:

to function as an action planning section creating, to control action of the robot apparatus, on the basis of an outside world map, a higher action plan including an optimal solution achieving an action target and enabling derivation of a suboptimal solution different from the optimal solution.

### REFERENCE SIGNS LIST

10: Robot apparatus
20: Path group
21: Optimal path
22: Moving path
23, 24: Higher action plan
31: Cooperating robot apparatus
100, 101: Control apparatus
110: Recognition section
120: Map creation section
130: Planning map creation section
140: Action planning section
141: Higher action planning section
142: Lower action planning section
150: Drive control section
161: Transmission section
162: Reception section
210: Sensor section
220: Drive section
230: Input section

1. An action planning apparatus comprising:
an action planning section that creates, to control action of a robot apparatus, on a basis of an outside world map, a higher action plan including an optimal solution achieving an action target and enabling derivation of a suboptimal solution different from the optimal solution.

2. The action planning apparatus according to claim 1, wherein the higher action plan includes a plurality of action plans and includes at least an action plan corresponding to the optimal solution and an action plan corresponding to the suboptimal solution.

3. The action planning apparatus according to claim 1, wherein the higher action plan includes an action plan with a distribution.

4. The action planning apparatus according to claim 3, wherein the higher action plan is created by bringing a distribution to the action plan corresponding to the optimal solution.

5. The action planning apparatus according to claim 3, wherein the higher action plan is created by converting a plurality of overlapping action plans into a distribution.

6. The action planning apparatus according to claim 2, wherein the number of action plans included in the higher action plan is controlled on the basis of the outside world map.

7. The action planning apparatus according to claim 3, wherein a magnitude of the distribution in the higher action plan is controlled on the basis of the outside world map.

8. The action planning apparatus according to claim 1, wherein the action planning section includes a higher action planning section that creates the higher action plan and a lower action planning section that creates, on a basis of the higher action plan, a lower action plan used to actually control the robot apparatus.

9. The action planning apparatus according to claim 8, wherein the lower action planning section differs from the higher action planning section in at least one of a period of creation of an action plan or a range of creation of an action plan.

10. The action planning apparatus according to claim 9, wherein the lower action planning section creates an action plan within a range spatially or temporarily more local than the higher action planning section.

11. The action planning apparatus according to claim 9, wherein the higher action planning section creates the higher action plan in consideration of a static object, and the lower action planning section creates the lower action plan in consideration of a dynamic object.

12. The action planning apparatus according to claim 8, wherein the lower action planning section creates the lower action plan on a basis of at least one of followability of a subject apparatus state of the robot apparatus, a possibility of a collision with an obstacle, or a previous action history.

13. The action planning apparatus according to claim 8, wherein the lower action planning section creates the lower action plan in such a manner as to reduce a deviation from an action plan corresponding to the optimal solution.

14. The action planning apparatus according to claim 8, wherein the lower action planning section creates an action plan up to an intermediate action target in the higher action plan.

15. The action planning apparatus according to claim 8, further comprising:
a communication section that is able to communicate with a cooperating robot apparatus acting cooperatively with the robot apparatus,
wherein the robot apparatus and the cooperating robot apparatus share the higher action plan via the communication section, and
the lower action planning section creates the lower action plan on a basis of each of the higher action plans.

16. The action planning apparatus according to claim 15, wherein the lower action planning section creates the lower action plan using an evaluation function common to the robot apparatus and the cooperating robot apparatus.

17. An action planning method comprising:
using a calculation apparatus to create, to control action of a robot apparatus, on a basis of an outside world map, a higher action plan including an optimal solution achieving an action target and enabling derivation of a suboptimal solution different from the optimal solution.

18. A program for causing a computer:
to function as an action planning section creating, to control action of the robot apparatus, on a basis of an outside world map, a higher action plan including an optimal solution achieving an action target and enabling derivation of a suboptimal solution different from the optimal solution.
